(19) United States
(12) Patent Application Publication
(10) Pub. No.: US 2017/0046865 A1
(43) Pub. Date: Feb. 16, 2017

(54) ANIMATION MOTION CAPTURE USING THREE-DIMENSIONAL SCANNER DATA

(71) Applicant: LUCASFILM ENTERTAINMENT COMPANY LTD., San Francisco, CA (US)

(72) Inventor: Brian Cantwell, Petaluma, CA (US)

(73) Assignee: LUCASFILM ENTERTAINMENT COMPANY LTD., San Francisco, CA (US)

(21) Appl. No.: 14/826,671

(22) Filed: Aug. 14, 2015

(51) Int. Cl. G06T 13/40; G06K 9/00; H04N 13/02; G06T 7/00; G06T 17/20; G06T 7/20

(52) U.S. Cl. CPC G06T 13/40; G06T 17/20; G06T 7/2093; H04N 13/0203; G06T 7/004; G06K 9/00711; G06T 2207/30196; G06T 2207/10028; G06T 2207/10021

(57) ABSTRACT

Systems and techniques are provided for performing animation motion capture of objects within an environment. For example, a method may include obtaining input data including a three-dimensional point cloud of the environment. The three-dimensional point cloud is generated using a three-dimensional laser scanner including multiple laser emitters and multiple laser receivers. The method may further include obtaining an animation model for an object within the environment. The animation model includes a mesh, an animation skeleton rig, and adjustable controls that control the animation skeleton rig to define a position of one or more faces of the mesh. The method may further include determining a pose of the object within the environment. Determining a pose includes fitting the one or more faces of the mesh to one or more points of a portion of the three-dimensional point cloud. The portion of the three-dimensional point cloud corresponds to the object in the environment. The fitting includes reducing errors between the one or more faces and the one or more corresponding points using the adjustable controls.

### FIELD

The present disclosure generally relates to animation motion capture using three-dimensional scanner data. For example, systems and techniques may be provided for capturing motion of objects within a scene using three-dimensional scanner data.

### BACKGROUND

Animation motion capture involves generating motion data that represents the motion of objects in a scene to accurately reproduce computer-generated representations of the objects. As the need for actor-driven, computer-generated characters within live action films continues to increase, so too does the need for a cost-effective solution for motion capture of an actor or other object on a set within the context of principle photography, rather than a separate dedicated motion capture volume. However, such a solution is difficult due to the arbitrary layout, size, and lighting conditions of the set. Current solutions have drawbacks related to the footprint and manpower required on set and cost of post-production to process the data. Embodiments of the invention address these and other problems both individually and collectively.

### SUMMARY

Techniques and systems are described for performing animation motion capture using three-dimensional scanner data. For example, a three-dimensional laser scanner may capture three-dimensional (3D) point data of an environment or scene. The 3D point data may include a 3D point cloud including groups of points that correspond to the various objects located within the environment. The 3D point data is used to determine poses of one or more objects located within the environment. To determine the pose of an object, an animation model for the object may be fit to a portion of the 3D point data that corresponds to the object. In some examples, a 3D laser scanner may perform several scans in a given amount of time (e.g., twenty scans per second), and can output a set of 3D point data per scan. In some examples, multiple 3D laser scanners located within and around the environment are used to capture various 3D point clouds of the environment from different perspectives.

According to at least one example, a computer-implemented method of performing animation motion capture of objects within an environment may be provided that includes obtaining input data including a three-dimensional point cloud of the environment. The three-dimensional point cloud is generated using a three-dimensional laser scanner including multiple laser emitters and multiple laser receivers. The method may further include obtaining an animation model for an object within the environment. The animation model includes a mesh, an animation skeleton rig, and adjustable controls that control the animation skeleton rig to define a position of one or more faces of the mesh. The method may further include determining a pose of the object within the environment. Determining a pose includes fitting the one or more faces of the mesh to one or more points of a portion of the three-dimensional point cloud. The portion of the three-dimensional point cloud corresponds to the object in the environment. The fitting includes reducing errors between the one or more faces and the one or more corresponding points using the adjustable controls.

In some embodiments, a system may be provided for performing animation motion capture of objects within an environment. The system includes a memory storing a plurality of instructions and one or more processors. The one or more processors are configurable to: obtain input data including a three-dimensional point cloud of the environment, the three-dimensional point cloud being generated using a three-dimensional laser scanner including multiple laser emitters and multiple laser receivers; obtain an animation model for an object within the environment, the animation model including a mesh, an animation skeleton rig, and adjustable controls that control the animation skeleton rig to define a position of one or more faces of the mesh; and determine a pose of the object within the environment, including fitting the one or more faces of the mesh to one or more points of a portion of the three-dimensional point cloud, the portion of the three-dimensional point cloud corresponding to the object in the environment, wherein fitting includes reducing errors between the one or more faces and the one or more corresponding points using the adjustable controls.

In some embodiments, a computer-readable memory storing a plurality of instructions executable by one or more processors may be provided. The plurality of instructions comprise: instructions that cause the one or more processors to obtain input data including a three-dimensional point cloud of an environment, the three-dimensional point cloud being generated using a three-dimensional laser scanner including multiple laser emitters and multiple laser receivers; instructions that cause the one or more processors to obtain an animation model for an object within the environment, the animation model including a mesh, an animation skeleton rig, and adjustable controls that control the animation skeleton rig to define a position of one or more faces of the mesh; and instructions that cause the one or more processors to determine a pose of the object within the environment, including fitting the one or more faces of the mesh to one or more points of a portion of the three-dimensional point cloud, the portion of the three-dimensional point cloud corresponding to the object in the environment, wherein fitting includes reducing errors between the one or more faces and the one or more corresponding points using the adjustable controls.

In some embodiments, the input data is captured using a plurality of three-dimensional laser scanners, and wherein the plurality of three-dimensional laser scanners operate in synchronization to capture the three-dimensional point cloud of the scene.

In some embodiments, the pose includes a skeletal position of the object.

In some embodiments, the three-dimensional point cloud is generated using the three-dimensional laser scanner by emitting lasers from the multiple laser emitters, receiving at the multiple laser receivers portions of the emitted lasers reflected by one or more objects, and determining an intensity of the received portions of the emitted lasers, an intensity of a portion of an emitted laser reflected by an object indicating a distance from the three-dimensional laser scanner to the object.

In some embodiments, the three-dimensional laser scanner has a range greater than thirty feet.

In some embodiments, the method, system, and computer-readable memory described above may further include: obtaining multiple frames, each frame of the multiple frames including a separate three-dimensional point cloud of the environment; and determining multiple poses of the object within the environment, wherein a pose of the object is determined for each frame of the multiple frames by refitting the animation model of the object to a portion of each separate three-dimensional point cloud in each frame that corresponds to the object in the environment.

In some embodiments, the three-dimensional point cloud includes a 360 degree azimuth field of view of the environment.

In some embodiments, the three-dimensional laser scanner sequentially generates multiple frames of three-dimensional point clouds in real-time.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will be described in more detail below in the following specification, claims, and accompanying drawings.

### BRIEF DESCRIPTION OF DRAWINGS

Illustrative embodiments of the present invention are described in detail below with reference to the following drawing figures:

FIG. 1 illustrates an example of an environment comprising a system for performing motion capture.

FIG. 2 illustrates an example of a three-dimensional laser scanner.

FIG. 3 illustrates an example of a system for performing motion capture of objects within an environment.

FIG. 4 illustrates an example of a fitting process.

FIG. 5 is a flow chart illustrating a process for performing animation motion capture of objects within an environment.

FIG. 6 shows an example of a computer system that may be used in various embodiments of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Motion capture techniques allow motion data to be generated based on tracking the movement of real objects. For example, motion data representing a realistic sequence of motion of a live object (e.g., a human actor or other object within an environment) can be captured. The motion data can then be used to drive the motion of an animated or computer-generated object that represents or corresponds to the live object. Techniques for capturing motion data may include capturing images of an actor wearing a body suit that is attached with retro-reflective objects (e.g., balls or other objects) at locations that correspond to the actor's joints (e.g., shoulder, elbow, wrist, or other joints). As the actor moves during a performance, a sequence of movements are digitally recorded by a number of cameras and processed to identify the retro-reflective balls as points. Triangulation can be performed on the points to determine the three-dimensional position of the point. A virtual skeleton representing or corresponding to the actor can be fit to the point movement collected over time to represent the motion of the actor.

For example, some techniques may use a motion capture (or mocap) system that uses custom mocap suits for each actor and a number of witness cameras viewing the action of a scene from vantage points in addition to the vantage point of a principal camera. The motion data is then tracked and solved to an actor skeleton. In another example, some systems may use active light emitting diode (LED)-based systems for on-set mocap. However, these setups have significant on-set setup cost, require a high number of witness cameras, and a large crew. In yet another example, a wearable mocap system may use orientation and inertial sensors to capture body movement. These suits do a good job of capturing overall movement, but the overall registration of the performance in three-dimensional space drifts over time.

Other techniques may use optical depth sensors to capture movement of a subject. One example of such a depth sensor is a Kinect™ depth sensor. However, these depth sensors have a short range or throw, which may be as low as ten to twenty feet, and are sensitive to lighting conditions of an environment.

Techniques and systems are described for performing animation motion capture of an environment using real-time three-dimensional scanner data. Unlike optical camera systems, real-time three-dimensional laser scanners can operate under a much wider range of lighting conditions, from bright sunlight to total darkness. Further, depth of field and framing of three-dimensional laser scanners is also not an issue, meaning that the laser scanners do not require dedicated operators for each scanner. The three-dimensional laser scanners also are designed to capture accurate depth information across much greater distances than depth sensors (e.g., Kinect™ or similar systems), and include a range of up to 100 meters or more.

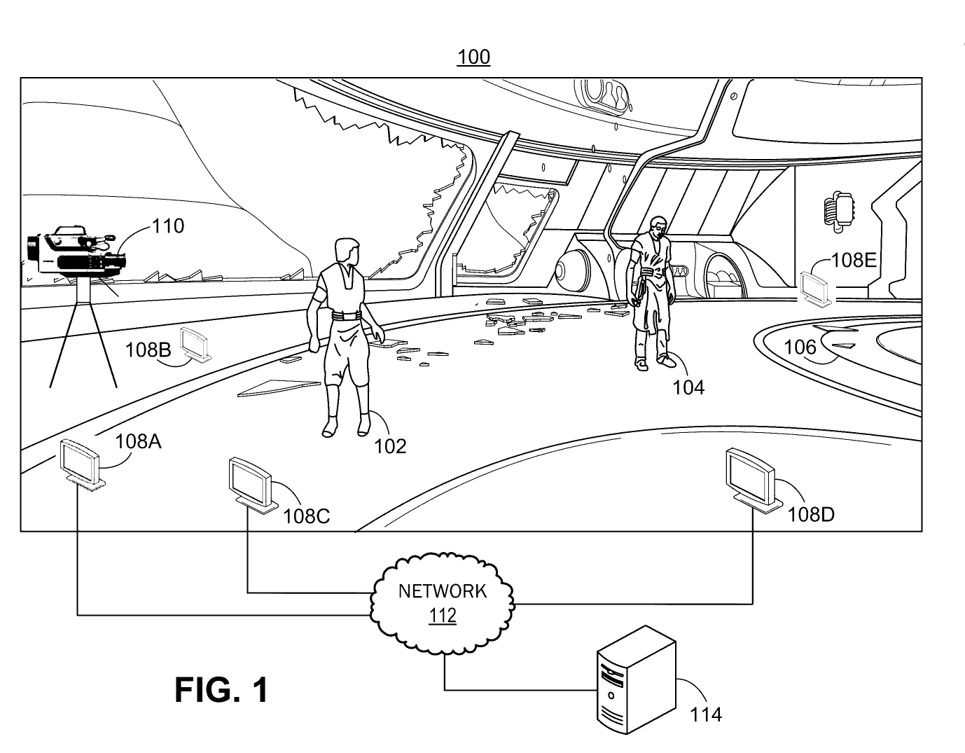

FIG. 1 illustrates an example of an environment 100 in which a system is used to perform motion capture of various objects within the environment 100 using three-dimensional laser scanners 108A-108E. The environment 100 may include a set in which a scene of a multimedia production (e.g., a movie, a video game, a cartoon, or any other multimedia) is shot using a principal camera 110. For example, the characters 102 and 104 may be live actors that are performing a scene of a movie. The movie may include an animated movie or a live-action movie with computer-generated representations or versions of the characters 102 and 104. Furthermore, computer-generated representations of other objects within the environment may also be portrayed in the movie, such as the wheel 106. Motion of the characters 102, 104, the wheel 106, and any other moving objects within the environment 100 may be captured using the three-dimensional scanner-based motion capture systems and techniques described herein. One of ordinary skill in the art will appreciate that motion capture data may be obtained for any object located in the environment 100 using the systems and techniques described herein. For example, objects may include, but are not limited to, actors, animals, vehicles, sets, props, or anything that has a solid or opaque surface and a consistent volume. In one example, other objects not shown in FIG. 1 that may be included in the scene include a vehicle or animal moving through the environment during the scene, an opaque window (e.g., an opaque window that is shattered during the scene and that can reflect a laser), a brick wall (e.g., a brick wall that is demolished during the scene), or any other object for which motion data can be used. Objects within the environment for which a computer-generated representation will be included in the multimedia production may be referred to herein as “objects of interest.”

To facilitate motion capture of one or more objects in the environment 100 for which motion capture data is desired (e.g., to drive movement of computer-generated representations the objects), a separate animation model may be generated for each of the one or more objects. For example, a first animation model may be generated for the character 102, a second animation model may be generated for the character 104, and a third animation model may be generated for the wheel 106. High-resolution scan data of each object may be obtained and used to generate the animation models. For example, the objects including each of the character 102, the character 104, and the wheel 106 may be digitally scanned using a three-dimensional (3D) image scanner (not shown) to obtain scan data of the objects. The 3D image scanner used to capture the scan data of the objects is a different device than the 3D laser scanners 108A-108E. For example, the 3D image scanner may include any scanner that can capture high-resolution surface detail of an object.

The scan data can be used to generate animation models for the characters 102, 104 and the wheel 106 (and for any other object in the environment for which a computer-generated representation will be included in the multimedia production). An animation model of the character 102, for example, can be generated by taking the scan data of the character 102 and translating the scan data to a meshed 3D model. In some examples, an automated 3D modeling process (e.g., a 3D modeling program or algorithm) may be performed on the scan data to interpret the 3D point data of the scan data into one or more logical faces of the character 102. The 3D modeling process may be facilitated by a 3D modeling package, such as Maya, 3dsMax, Modo or any other suitable 3D modeling package. In other examples, a human digital modeler can interpret the 3D point data into the logical faces, which can then be input into a modeling or rigging program. The 3D modeling process results in a fully meshed 3D model. The meshed 3D model may include the 3D model with a polygonal mesh. For example, the meshed 3D model may include various points (or vertices), with two points connecting to make an edge, and three or four edges connecting to make a face (three edges defining a triangle face, and four edges defining a quad face). The points, edges, and faces define the mesh. The system may store the points, edges, and faces. In some embodiments, the mesh may further include polygons or surfaces (made up of a set of faces), which may also be stored by the system. One or more of the meshes are used to make the meshed 3D model. A renderer may be used to render the meshed 3D model using the stored polygonal mesh data.

The fully meshed model is then rigged for animation so that the meshed model can be posed and animated in a logical way using a skeleton, joints, and/or skinning. The fully meshed model may be rigged using a rigging process facilitated by a suitable program (e.g., Maya, 3dsMax, or any other suitable rigging package). A rig abstracts the motion of the meshed model geometry through a skeleton rig, which may move entire meshes around (e.g., in a car mesh), or may move individual points of the mesh around (e.g., a human mesh, an animal mesh, or mesh of some other soft-deforming object). In one example, a leg of the character 102 may be represented by one mesh or a section of a larger mesh that makes up the character 102. Control of the rigged meshed model can be performed using adjustable controls that control a position of the skeleton and/or joints of the model. In some embodiments, to move the rigged meshed model, the individual points are not moved, but instead a joint (e.g., a hip or knee joint) in the skeleton is moved, which in turn causes the individual points correlated with the joint to move in a natural way. This type of point manipulation via a skeleton rig is referred to as skinning, in which each bone and joint in the skeleton rig is associated with a portion of an object's mesh. For instance, a bone and/or a joint is associated a group of vertices or points of the mesh with which the bone or joint will be associated. In one example, a shin bone of the skeleton rig of the character 102 may be associated with points making up the polygonal faces of the character's 3D meshed model. In some instances, multiple bones or joints may be associated with multiple portions of an object's meshed model, and skinning or vertex weights may be used to determine how much each bone affects each point of the portions when moved in a particular manner (e.g., each point or vertex may have a skinning weight for each bone). The rigged meshed model makes up the animation model for the character 102, and includes one or more faces, an animation skeleton rig (e.g., including a skeleton and joints), and adjustable controls that control the animation skeleton rig to define a position of the one or more faces of the animation model. A similar technique may be performed to generate animation models for the other objects in the environment 100 for which a computer-generated representation will be included in the multimedia production, such as character 104 and the wheel 106.

The scan data and the animation models for the objects may be obtained and generated prior to recording of the scene in the environment 100. Details of the scene may also be planned before the scene is shot. For example, the action of the scene may be designed and rehearsed in the physical environment 100 with the camera 110, the characters 102, 104, and other objects of the scene so that the 3D laser scanners 108A-108E can be properly placed throughout the environment 100. The 3D laser scanners 108A-108E are placed in a configuration so that all objects of interest are captured by one or more of the 3D laser scanners 108A-108E to ensure that motion of the objects can be observed using data from the 3D laser scanners 108A-108E. The 3D laser scanners 108A-108E are also placed so that occlusion of objects of interest by other objects is minimized. In another example, the action of the scene can be designed and rehearsed within a digital 3D scene that portrays the environment 100 (e.g., using a program such as Maya, 3dsMax, or the like). The digital design and rehearsal of the scene can be performed using pre-visualization, which includes the process of conducting digital shot design by roughly animating the objects to determine composition, lenses, measurements, timing, or other parameters in advance of the actual shoot.

The 3D laser scanners 108A-108E can then be appropriately placed throughout the environment 100. As explained in more detail below, the 3D laser scanners 108A-108E provide 3D point cloud data indicative of locations and positions of various objects by emitting lasers and receiving portions of the emitted lasers reflected by the various objects. In one example, the 3D laser scanners 108A-108E can be placed in and around the environment (e.g., in a circular configuration or other appropriate configuration around the objects of interest) using the information obtained during the rehearsal and/or previsualization described above. The configuration of the 3D laser scanners 108A-108E around the environment 100 can be determined so that each 3D laser scanner 108A-108E can view one or more of the objects of interest in the scene, but is also not in the way of the principal camera 110 or the action of the objects of interest. The exact number of 3D laser scanners 108A-108E required to properly capture motion of all objects of interest in the scene will vary depending upon the number and position of objects of interest in the scene, as well as the overall size of the action area. In some embodiments, at minimum there should be enough 3D laser scanners 108A-108E such that the action of all objects of interest in the scene can be viewed from all sides by at least one of the 3D laser scanners 108A-108E at any given moment in time. The laser scanners 108A-108E are also placed so that occlusions, caused by objects in the scene blocking other objects, are avoided, since occlusions will cause blind spots in the 3D point data. In the event occlusions are discovered, additional 3D laser scanners (one of 3D laser scanners 108A-108E or other 3D laser scanners) can be placed in the environment 100 to fill in the blind spots. The real-time output of the 3D laser scanner 108A-108E can be used to verify full coverage of the objects of interest in the scene. For example, the 3D point data output from the 3D laser scanners 108A-108E can be observed to determine whether any of the objects of interest are not properly captured in the 3D point data. In the event an object, or a portion of an object, is not captured by any of the 3D laser scanners 108A-108E, the configuration of the 3D laser scanners 108A-108E throughout the environment can be adjusted.

In some embodiments, one or more of the 3D laser scanners 108A-108E can be attached to an object, and the 3D laser scanners 108A-108E do not need to remain stationary during shooting of the scene. For example, the systems and techniques described herein can use the 3D laser scanners 108A-108E to compute not only the location of the objects of interest in the environment 100, but also to compute the location of other 3D laser scanners 108A-108E relative to objects of interest. For example, one of the 3D laser scanners 108-108E may be mounted to a moving object (e.g., a vehicle, aircraft, drone, or other moving object) to maintain optimal coverage over the course of the shot as the object moves.

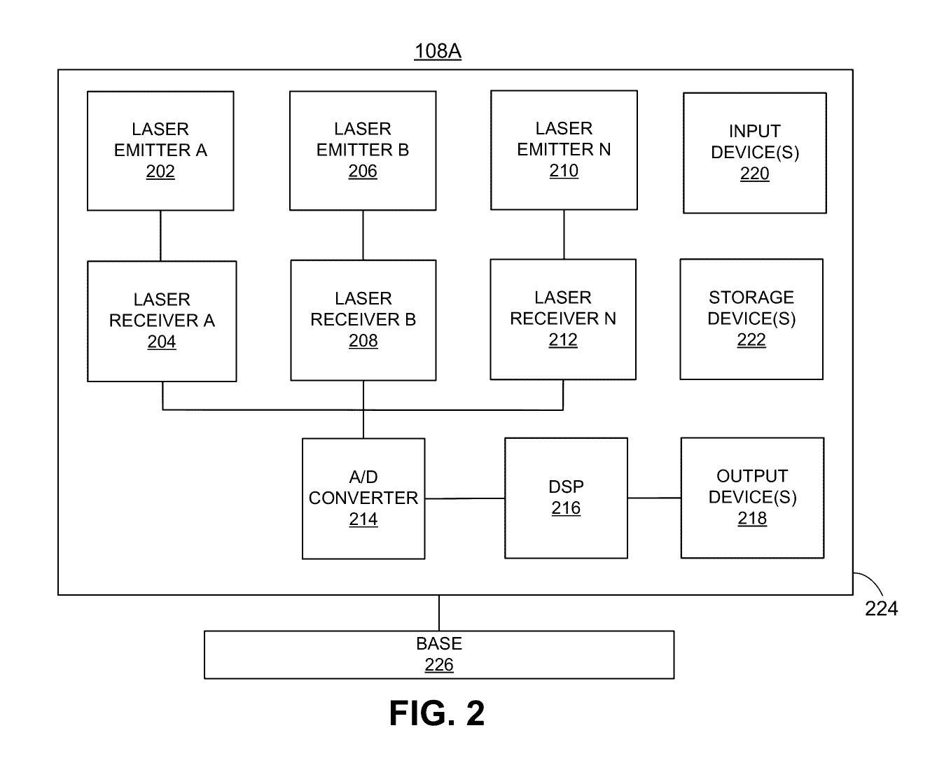

Once the details of the scene are planned and the 3D laser scanners 108A-108E are placed throughout the environment 100, the scene is shot using the principal camera 110 while the 3D laser scanners 108A-108E are running or operating. The three-dimensional laser scanners 108A-108E may capture 3D point data of the environment 100 as the scene is shot by the principal camera 110. Each of the 3D laser scanners 108A-108E may include a light detection and ranging (Lidar) scanner. For example, the 3D laser scanner 108A includes a number of laser emitters and a number of laser receivers that are used to collect the 3D point data. The 3D point data includes a 3D point cloud that is output during each scan of a 3D laser scanner 108A-108E. The point cloud includes groups of points that resemble the various objects located within the environment 100, with each point within the 3D point cloud indicating a 3D point in space. Accordingly, the rendered 3D point cloud will display points outlining the various objects within the environment 100. The 3D laser scanners 108A-108E may perform numerous scans in an amount of time. For example, the 3D laser scanner 108A-108E may perform one scan per second, five scans per second, twenty scans per second, or any other number of scans per second, depending on the hardware capabilities of the 3D laser scanners 108A-108E. Each scan performed by a 3D laser scanner (e.g., 3D laser scanner 108A) includes a 3D point cloud. Further details describing the components and operation of a 3D laser scanner are described with reference to FIG. 2.

FIG. 2 illustrates an example of a 3D laser scanner 108A. The details discussed herein with respect to the 3D laser scanner 108A apply equally to the other 3D laser scanners 108B-108E shown in FIG. 1. The 3D laser scanner 108A is a light detection and ranging (Lidar) scanner, and includes multiple laser emitters (laser emitter A 202, laser emitter B 206, and laser emitter N 210) and multiple laser receivers (laser receiver A 204, laser receiver B 208, and laser receiver N 212). The laser emitter A 202 and laser receiver A 204 can be referred to as emitter-receiver pair A, the laser emitter B 206 and laser receiver B 208 can be referred to as emitter-receiver pair B, and the laser emitter N 210 and laser receiver N 212 can be referred to as emitter-receiver pair N. While only three laser-emitter pairs are shown in FIG. 2, one of ordinary skill in the art will appreciate that the 3D laser scanner 108A can include more or less laser-emitter pairs. For example, the 3D laser scanner 108A may include two, four, six, eight, ten, twelve, sixteen, twenty, twenty-four, twenty-eight, thirty-two, sixty-four, or any other suitable number of laser-receiver pairs.

The laser emitters (laser emitter A 202, laser emitter B 206, laser emitter N 210) include a laser light source that emits an optical laser. The emitted laser signal is focused using a lens. In some embodiments, each of the laser emitters 202, 206, 210 includes a separate lens. In other embodiments, two or more of the laser emitters 202, 206, or 210 may share a lens. When the laser (e.g., a laser emitted by laser emitter A 202) contacts a target object, at least a portion of the laser is reflected by the surface of the target back towards the source (e.g., the laser emitter A 202 that emitted the laser). The reflected laser returns to the 3D laser scanner 108A, and is received using a return lens. In some embodiments, the return lens is the same lens as the lens used to focus the emitted laser. In other embodiments, a separate return lens is included in the laser receiver to focus the return laser to the particular laser receiver. Each of the laser receivers 204, 208, 212 may include a separate return lens, or two or more of the laser receivers 204, 208, 212 may share a return lens. In some examples, a filter (e.g., a ultra-violet light filter) may filter out light energy in the return laser that is introduced by ambient light, such as sunlight or artificial lighting in the environment 100. The ambient light may introduce added energy in the return laser, which may degrade the signal-to-noise ratio of the laser signal and cause errors in intensity readings. Each of the laser receivers 204, 208, 212 may include a separate UV light filter, or two or more of the laser receivers 204, 208, 212 may share a UV light filter. The return lens of each laser receiver (laser receiver A 204, laser receiver B 208, laser receiver N 212) focuses the reflected laser to a diode or other electronic component that can generate an output signal indicative of the strength or intensity of the reflected laser. The diode may include a photodiode that converts light (the laser signal) into a current or a voltage. The strength or intensity of the reflected laser is indicative of the distance from the 3D laser scanner to the target object.

In some embodiments, the strength or intensity of the laser light source may be adjusted based on a strength or intensity of the reflected return laser signal, as detected by the diode. For example, if the return laser signal is below a certain intensity level, the laser source may be automatically increased to emit a stronger laser signal. In another example, the laser source may be decreased to emit a weaker laser signal when a return laser signal is above the intensity level. The strength of the return signal may vary due to various factors, such as distance from a target object that reflects the laser, color of a surface of a target object (e.g., black objects absorb more light, thus reflecting less of the laser signal), or other relevant factors.

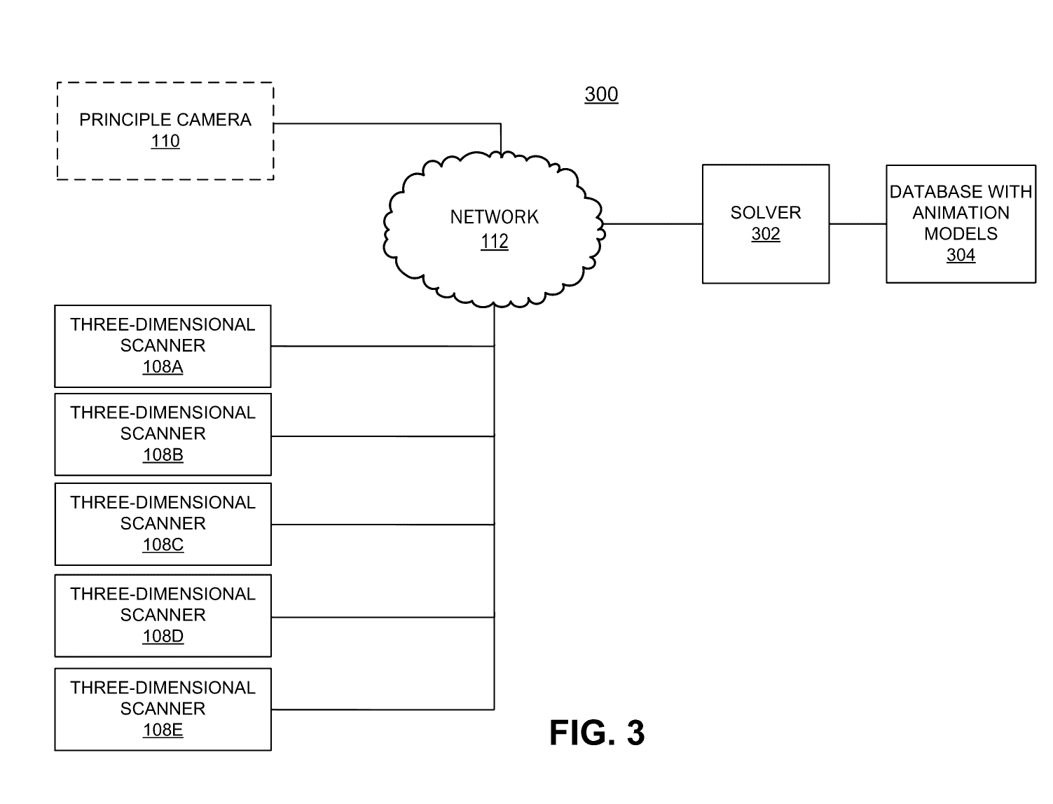

The output signal provided by the diode of a laser receiver (laser receiver A 204, laser receiver B 208, or laser receiver N 212) may be amplified using a current amplifier (not shown) or voltage amplifier (not shown). The amplified signal may then be sent to the analog to digital (A/D) converter 214 for conversion from an analog current or voltage signal to a digital output signal. The digital output signal is then passed to a digital signal processor (DSP) 216 that processes the signal. The DSP 216 may determine the time at which the reflected laser was received. The digital output signal can then be output by the output device 218 to an external computing device (e.g., a personal computer, a laptop computer, a tablet computer, a mobile device, or any other suitable computing device). The output device 218 can include a serial port, an Ethernet port, a wireless interface (e.g., a wireless receiver or transceiver), or other suitable output that can send output signals to an external device. In some embodiments, the output data may be stored in a storage device 222. In some embodiments, the storage device 222 may store software (e.g., firmware, or other appropriate software) needed for the 3D laser scanner 108A to operate. Output data containing output signals from each of the emitter-receiver pairs may be periodically or continuously output at a particular frame rate by the output device 218. The frame rate can be adjusted based on the application. The output data includes 3D point data comprising a 3D point cloud for each scan (according to the frame rate). The 3D point cloud data indicates the points surrounding the volume of each object in the scene (as the lasers reflect off of the surfaces of the objects), and thus provides a shape of each object in 3D space. The collection of points for each object and/or the identified shape of the object can be tracked over a series of 3D point clouds in order to determine the motion of the object. In some examples, the output data may include the distance and intensity data, as detected by each emitter-receiver pair, and an angle at which the distance and intensity data was obtained. For example, as described above, the strength or intensity of a reflected laser is indicative of a distance from the 3D laser scanner to a target object. The angle may be determined based on an orientation of the laser emitter and receiver of each emitter-receiver pair. The output data is used by a solver (e.g., solver 302) in a motion capture determination, as described below with reference to FIG. 3.

The 3D laser scanner 108A can be configured to provide an expansive elevation field of view and azimuth field of view. For example, each of the laser emitter-receiver pairs A, B, and N are aligned to provide a spaced elevation field of view of the environment 100 at a certain angle. For example, the laser emitter-receiver pairs A, B, and N may be equally spaced to provide a 10°, 20°, 30° (or other suitable angle) elevation field of view. In embodiments in which more emitter-receiver pairs are provided (e.g., thirty-two or sixty-four emitter-detector pairs), the emitter-receiver pairs may be equally spaced to provide a 25° elevation field of view, spanning from 2° to −23°. The 3D laser scanner 108A includes a base 218 about which an upper portion 224 rotates to provide a full 360° azimuth field of view. In some embodiments, the upper portion 224 may rotate about the base 218 to provide an azimuth field of view that is less than 360°, such as at 180°, 270°, or other suitable azimuth angle. In some embodiments, the 3D laser scanner 108A may not rotate about the base 218, and can remain stationary as the point data is obtained. The rotation or non-rotation of the 3D laser scanner 108 can be a configurable or selectable option that a user may select, for example, using one or more input device(s) 220. The input device 220 may include a serial port, a wireless interface (e.g., a wireless receiver or transceiver), or other suitable input that can receive commands from an external computing device (e.g., a personal computer, a laptop computer, a tablet computer, a mobile device, or any other suitable computing device).

In some cases, the 3D laser scanner 108A is not capturing the scene a single instant in time, but rather, the scene is captured at each degree of rotation at a slightly different time. In photography, this concept is referred to as “rolling shutter,” in which case one side of the image is captured at a slightly different time than the other side of the image. To correct the rolling shutter issue, the 3D point data is offset in time according to the rate of spin of the 3D laser scanner 108A in order to get pinpoint accuracy.

In some embodiments, the 3D laser scanner 108A includes a position locating device, such as a global positioning system (GPS) location sensor, or other suitable position locating device. The position locating device allows the 3D laser scanner 108A to determine a location of the 3D laser scanner 108A. The location may be used in the motion capture techniques described herein, such as to determine the location of a particular character 102, 104 or object in the environment during a shoot. In some embodiments, the 3D laser scanner 108A can perform triangulation or trilateration using received signals (e.g., WiFi signals, cellular signals, or other wireless signals) to determine a location of the 3D laser scanner 108A.

In some embodiments, the 3D laser scanners 108A-108E are synchronized so that they operate in synchronization with one another. For example, the 3D laser scanners 108A-108E may include GPS synchronized clocks. The 3D laser scanners 108A-108E may be synchronized to a single GPS clock, which will keep the scanners from falling out of sync with each other.

FIG. 3 illustrates an example of a system 300 for performing motion capture of an environment (e.g., environment 100). The system 300 includes a solver 302 that obtains 3D point cloud output data from the 3D scanners 108A-108E. The solver 302 receives the output data over the network 112. The network 112 may include a wireless network, a wired network, or a combination of a wired and wireless network. A wireless network may include any wireless interface or combination of wireless interfaces (e.g., WiFi™, cellular, Bluetooth™, Long-Term Evolution (LTE), WiMax™, or the like). A wired network may include any wired interface (e.g., serial interface, fiber, ethernet, powerline ethernet, ethernet over coaxial cable, digital signal line (DSL), or the like). The network 112 may be implemented using various devices, such as routers, access points, bridges, gateways, or the like, to connect the devices in system 300.

The solver 302 also obtains animation models for objects of interest from a database 304. As previously described, an animation model for an object of interest includes the rigged meshed model for that object of interest, and includes one or more faces, an animation skeleton rig (e.g., including a skeleton and joints), and adjustable controls (or adjustable rig controls) that control the animation skeleton rig to define a position of the one or more faces of the animation model.

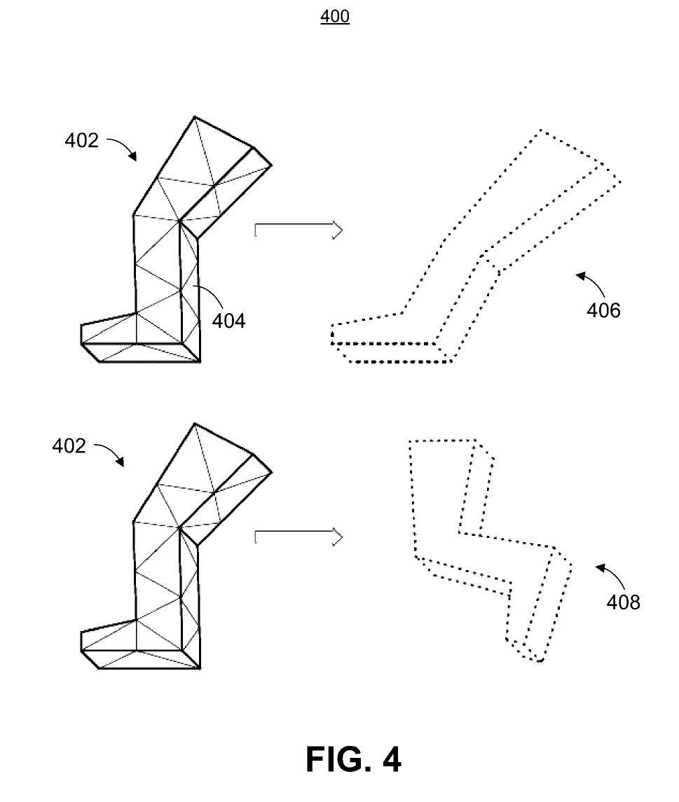

The solver 302 solves for the position and pose of the objects of interest in the environment 100 by performing a fitting process using the 3D point cloud data and the animation models. The 3D point cloud data indicates the points surrounding the volume of each object (as the lasers reflect off of the surfaces of the objects), and thus provides a shape of each object in 3D space. For example, FIG. 4 illustrates an example of fitting a rigged 3D mesh 402 of a leg portion of an animation model for a live character. The rigged 3D mesh 402 is made up of numerous polygonal faces, including face 404, that are fit to a first 3D point cloud 406 of a first scan (or frame) from a 3D laser scanner. The first 3D point cloud 406 includes points showing an outline of the live character's leg in the scene being in an extended pose. The faces of the rigged 3D mesh 402 are then fit to a second 3D point cloud 408 of a second scan (or frame) from the 3D laser scanner. The second 3D point cloud 408 includes points showing an outline of the live character's leg in a different pose. The 3D point clouds 406 and 408 show two poses of the character at two different times, indicating that the live character is in motion during shooting of the scene (e.g., running through the environment 100). The 3D point clouds 406 and 408 achieved from the 3D laser scanner can thus be used to track the motion of the character during the scene.

As previously noted, the 3D point cloud data output by a 3D laser scanner is changing per frame or scan (e.g., several times per second), thus providing information that can be used to track the motion of the objects. The solver 302 solves for the position or pose of the objects of interest in the environment 100 by performing a fitting process using the 3D point cloud data and the animation models. For example, the solver 302 uses the 3D point cloud data output from the 3D laser scanners 108A-108B, along with an animation model (including a rigged meshed model) of an object of interest (e.g., character 102, character 104, wheel 106, or other object of interest), and fits the faces of the animation model to points of the 3D point cloud. The solver 302 performs the fitting by applying error minimization algorithms to solve for the position of the rigged meshed model within the point cloud. Using the error minimization algorithms, the pose of the character 102, for example, is solved for by minimizing the distance between the 3D cloud points corresponding to the character 102 and the faces of the animation model that is generated for the character 102. The solver 302 refits an object's animation model to the updated 3D point cloud data provided in successive frames output by the various 3D laser scanners 108A-108B (e.g., as shown in FIG. 4). For example, the solver 302 will obtain the multiple frames provided by a 3D laser scanner (e.g., at a rate of ten frames per second or other suitable frame rate), with each frame of the multiple frames including a separate 3D point cloud of the environment 100. The solver 302 can then determine multiple poses of an object of interest within the environment over time, with each pose being determined from a frame by refitting the animation model of the object to the portion of the 3D point cloud of the frame that corresponds to the object.

The solver 302 uses the adjustable rig controls of the animation model for the character 102 to fit the faces of the animation model to the points in the 3D point cloud that correspond to the character 102. For example, the solver iteratively changes the control values of the rigged meshed model of the animation model until a fit is achieved. Constraints may be applied to the solver 302 so that the solver 302 can only manipulate portions of the rigged meshed model in certain ways. For example, a constraint may limit the solver 302 to rotate the hip joint of the skeleton rig of the animation model (which is a socket joint that can freely rotate in any direction) or bend the knee (which is restricted to a rotation in one axis). The solver 302 will keep applying new values to the adjustable controls until the solver 302 achieves the best fit between the animation model and the 3D cloud points. The solver 302 uses the determined error as a guide during the fitting. For example, the further off the points in the 3D point cloud are from the faces of the rigged meshed model, the higher the error. The solver 302 can then minimize this error to find the best fit. The pose and position of the object of interest, and thus the captured motion for the object, is defined by the fit.

In some embodiments, the portion of the 3D point cloud that corresponds to a particular object of interest may be determined so that the solver 302 can analyze the relevant point data when capturing the motion of the object of interest. In some examples, the solver 302 may test a large set of possible point-to-animation model matches for an object of interest. The solver 302 minimizes the error to determine which portion of points in the point cloud best matches the object's animation model. In one example, each object represented in the 3D point cloud data is tested against an animation model for the object of interest to determine if a match exists. In some examples, a priming step may be performed, in which an initial rough positioning of an animation model of an object relative to one time sample (e.g., one scan) of 3D point cloud data may be made. After the initial positioning, the solver 302 can make incremental adjustments to the position or pose of the animation model as it progresses through subsequent temporal samples (per scan or frame) of 3D cloud data. The priming step may be performed in certain situations, such as when many objects of interest are included in a scene, or when there are two or more similarly-shaped objects of interest (e.g., two human actors, two similarly-shaped vehicles, or the like).

The solver 302 may solve for the motion capture data (including pose and position) of each object of interest using the data received from all of the 3D laser scanners 108A-108E. By using multiple scans of point data from multiple 3D laser scanners placed around the set and operating in synchronization, the movement and position of all objects of interest in the scene can be captured. The motion capture data can be used to animate the computer-generated representations of the objects of interest. For example, a computer-generated representation of the character 102 may be animated so that the computer-generated representation moves similarly to how the live character 102 moves when the scene was shot. In some cases, the computer-generated representation of an object may be part of the object's animation model (e.g., as part of the meshed 3D model).

In some embodiments, the animation can be refined by combining the solving process described above (using the point data from the 3D laser scanners 108A-108E) with other image-based tracking and matchmoving techniques. For instance, it may be determined that the final solved animation of the animation model is not at a high enough accuracy level. In such an instance, the final animation may be refined using motion picture camera imagery using images from the principal camera 110 or one or more witness cameras viewing the scene from additional vantage points. For example, image-based pattern tracking can be used to match specific features on each object of interest. These specific features can then be correlated to 3D positions on an animation model and solved in to place using a matchmove solver to refine the exact placement of the rigged models relative to principal camera or witness camera. Furthermore, motion capture techniques using mocap suits can also be used to supplement the motion capture data determined using the 3D laser scanners.

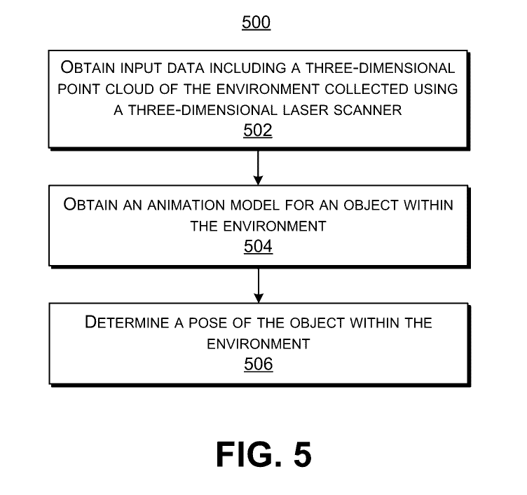

FIG. 5 illustrates an example of a process 500 of performing animation motion capture of objects within an environment using 3D point data from one or more three-dimensional laser scanners. Process 500 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500 may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program comprising a plurality of instructions executable by one or more processors. The computer-readable storage medium may be non-transitory.

In some aspects, the process 500 may be performed by a computing device, such as the solver 302 or the computing system 600 implementing the solver 302. For example, the computing system 600 may implement the solver 302 to perform the process 500.

At 502, the process 500 includes obtaining input data including a three-dimensional point cloud of an environment. The three-dimensional point cloud is generated or collected using a three-dimensional laser scanner that includes multiple laser emitters and multiple laser receivers. For example, the three-dimensional laser scanner may include any one of the three-dimensional laser scanner 108A-108E described above. In one example, the three-dimensional laser scanner includes the three-dimensional laser scanner 108A, the multiple laser emitters include the laser emitter A 202, the laser emitter B 206, and the laser emitter N 210, and the multiple laser receivers include the laser receiver A 204, the laser receiver B 208, and the laser receiver N 212.

At 504, the process 500 includes obtaining an animation model for an object within the environment. The animation model includes a mesh (e.g., a meshed 3D model of the object), an animation skeleton rig, and adjustable controls that control the animation skeleton rig to define a position of one or more faces of the mesh. For example, as previously described, the mesh (or meshed 3D model) can be rigged for animation so that the mesh can be posed and animated in a logical way using the skeleton rig and adjustable controls.

At 506, the process 500 includes determining a pose of the object within the environment, including fitting the one or more faces of the mesh to one or more points of a portion of the three-dimensional point cloud. The portion of the three-dimensional point cloud corresponds to the object in the environment. The fitting includes reducing errors between the one or more faces and the one or more corresponding points using the adjustable controls. For example, error minimization algorithms may be used to solve for the pose of the object by minimizing the distance between the three-dimensional cloud points corresponding to the object and the faces of the animation model that is generated for the object. Control values of the adjustable controls of the animation model may be adjusted until a fit is achieved. In some examples, constraints may be applied so that the animation model can be manipulated in certain ways, as previously described. New control values can be applied to the adjustable controls until a fit is achieved between the faces of the animation model and the one or more points of the three-dimensional point cloud. The determined error can be used as a guide during the fitting. For example, the further off the one or more points in the three-dimensional point cloud are from the faces of the animation model, the higher the error. The error may be minimized to find the best fit. The determined pose defines the motion for the object.

The portion of the three-dimensional point cloud that corresponds to the object can be determined as described previously. For example, a set of possible matches can be determined between the animation model for the object and the points corresponding to the object. The error can be minimized to determine which portion of points in the three-dimensional point cloud best matches the object's animation model. In some examples, a priming step may be performed, as previously described.

In some embodiments, the input data is captured using a plurality of three-dimensional laser scanners. For example, the plurality of three-dimensional laser scanners may include the three-dimensional scanners 108A-108E. In some examples, the plurality of three-dimensional laser scanners operate in synchronization to capture the three-dimensional point cloud of the scene. For example, the plurality of three-dimensional laser scanners may include GPS synchronized clocks, and may be synchronized to a single GPS clock.

In some embodiments, the pose includes a skeletal position of the object. For example, the determined pose may indicate the position of one or more bones of the character, as defined by the mesh and the animation skeleton rig.

In some embodiments, three-dimensional point cloud is generated using the three-dimensional laser scanner by emitting lasers from the multiple laser emitters, receiving at the multiple laser receivers portions of the emitted lasers reflected by one or more objects, and determining an intensity of the received portions of the emitted lasers. An intensity or strength of a portion of an emitted laser reflected by an object indicates a distance from the three-dimensional laser scanner to the object. The distance provides a point of the object in 3D space relative to the three-dimensional laser scanner.

In some embodiments, the three-dimensional laser scanner has a range greater than thirty feet. For example, unlike optical camera systems, the three-dimensional laser scanner is configured to capture accurate depth information across large distances using laser signals. In one example, the three-dimensional laser scanner has a range of up to 100 meters or more. For example, the laser emitters of the three-dimensional laser scanner may emit a laser that can travel a distance of up to 100 meters or more, reflect off of an object, and return to the three-dimensional scanner for obtaining a reading. The range may be configurable by a user anywhere in the range of up to 100 meters or more, such as ten meters, twenty meters, thirty meters, forty meters, fifty meters, seventy-five meters, 100 meters, 120 meters, or other suitable range. The range may depend on the ability of the laser emitters of the three-dimensional laser scanner.

In some embodiments, the process 500 includes obtaining multiple frames, each frame of the multiple frames including a separate three-dimensional point cloud of the environment. Each frame may be output during a scan of the three-dimensional scanner (e.g., when a laser is emitted and the reflected laser is received and processed to produce output data). The process 500 may further include determining multiple poses of the object within the environment, wherein a pose of the object is determined for each frame of the multiple frames by refitting the animation model of the object to a portion of each separate three-dimensional point cloud in each frame that corresponds to the object in the environment. For example, the solver 302 shown in FIG. 3 may perform the fitting described above for each frame of 3D cloud point data. Over time, the frame-by-frame refitting portrays the captured motion of the object. In some embodiments, the three-dimensional laser scanner sequentially generates multiple frames of three-dimensional point clouds in real-time.

In some embodiments, the three-dimensional point cloud includes a 360° azimuth field of view of the environment. For example, the three-dimensional scanner may rotate on a base (e.g., base 226) to provide the 360° azimuth field of view.

The motion capture data determined for a live object using 3D point cloud data, as described above, can be used to drive the motion of an animated object that represents or corresponds to the live object in a virtual scene. The virtual scene can undergo post-processing, and can then be rendered into two-dimensional or three-dimensional images or video for use in an item of media content, such as a feature film or a game. Using the motion capture data, the animated object will move in the virtual scene in a manner that is similar the movement of the live object in the live scene.

Using the above-described systems and techniques using 3D point cloud data from three-dimensional laser scanners, the movement and position of all objects of interest on a set can be captured, from actors to vehicles and props, and even destruction for post-production use. The motion capture using the three-dimensional laser scanners does not require custom suits, or tracking markers. In essence, every solid object in the scene can be captured for later use in post-production without using expensive equipment.

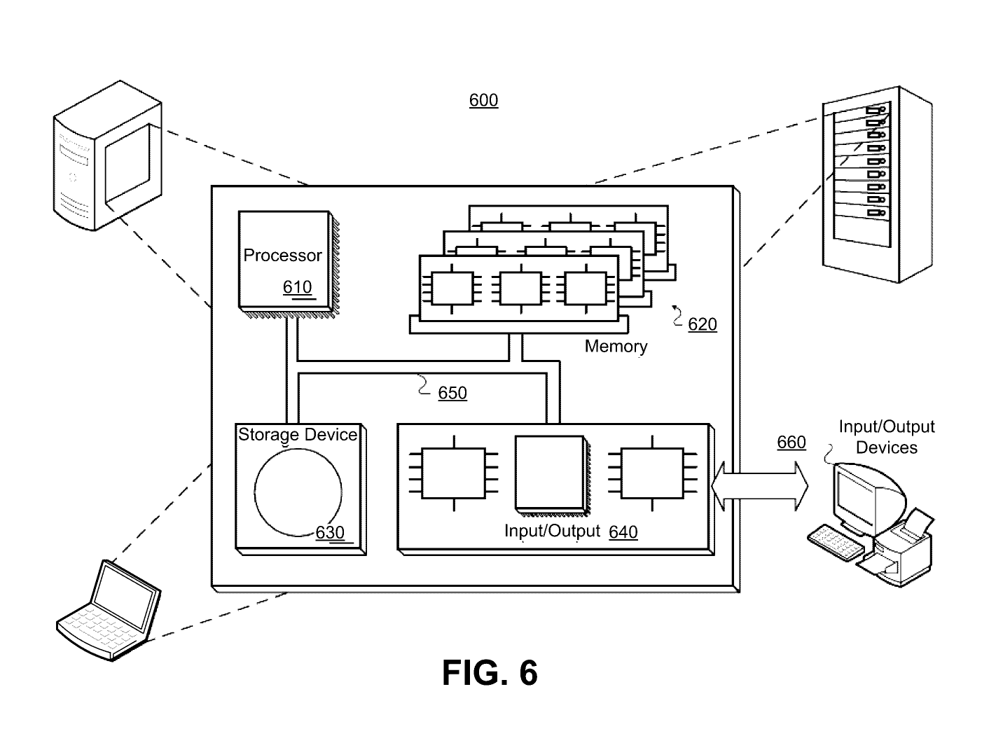

Referring to FIG. 6, a schematic diagram is shown of an example of a computing system 600. The computing system 600 is exemplary only and one having skill in the art will recognize that variations and modifications are possible. The computing system 600 can be used for the operations described above. For example, the computing system 600 may be used to implement any or all of the motion capture techniques described herein.

The system 600 includes a processor 610, a memory 620, a storage device 630, and an input/output interface 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to provide graphical information via input/output interface 640 for display on a user interface of one or more input/output device 660.

The memory 620 stores information within the system 600 and may be associated with various characteristics and implementations. For example, the memory 620 may include various types of computer-readable medium such as volatile memory, a non-volatile memory and other types of memory technology, individually or in combination.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 660 provides input/output operations for the system 600. In one implementation, the input/output device 660 includes a keyboard and/or pointing device. In another implementation, the input/output device 660 includes a display unit for displaying graphical user interfaces.

The features described herein can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube), LCD (liquid crystal display), LED (light emitting diode) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other. Although a few implementations have been described in detail above, other modifications are possible.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

A number of embodiments of the invention have been described. Nevertheless, it will be understood that various modification may be made without departing from the scope of the invention.

What is claimed is:

1. A computer-implemented method of performing animation motion capture of objects within an environment, comprising:
obtaining input data including a three-dimensional point cloud of the environment, the three-dimensional point cloud being generated using a three-dimensional laser scanner including multiple laser emitters and multiple laser receivers;
obtaining an animation model for an object within the environment, the animation model including a mesh, an animation skeleton rig, and adjustable controls that control the animation skeleton rig to define a position of one or more faces of the mesh; and
determining a pose of the object within the environment, including fitting the one or more faces of the mesh to one or more points of a portion of the three-dimensional point cloud, the portion of the three-dimensional point cloud corresponding to the object in the environment, wherein fitting includes reducing errors between the one or more faces and the one or more corresponding points using the adjustable controls.

2. The method of claim 1, wherein the input data is captured using a plurality of three-dimensional laser scanners, and wherein the plurality of three-dimensional laser scanners operate in synchronization to capture the three-dimensional point cloud of the scene.

3. The method of claim 1, wherein the three-dimensional point cloud is generated using the three-dimensional laser scanner by emitting lasers from the multiple laser emitters, receiving at the multiple laser receivers portions of the emitted lasers reflected by one or more objects, and determining an intensity of the received portions of the emitted lasers, an intensity of a portion of an emitted laser reflected by an object indicating a distance from the three-dimensional laser scanner to the object.

4. The method of claim 1, wherein the three-dimensional laser scanner has a range greater than thirty feet.

5. The method of claim 1, further comprising:
obtaining multiple frames, each frame of the multiple frames including a separate three-dimensional point cloud of the environment; and
determining multiple poses of the object within the environment, wherein a pose of the object is determined for each frame of the multiple frames by refitting the animation model of the object to a portion of each separate three-dimensional point cloud in each frame that corresponds to the object in the environment.

6. The method of claim 1, wherein the three-dimensional point cloud includes a 360 degree azimuth field of view of the environment.

7. The method of claim 1, wherein the three-dimensional laser scanner sequentially generates multiple frames of three-dimensional point clouds in real-time.

8. A system for performing animation motion capture of objects within an environment, comprising:
a memory storing a plurality of instructions; and
one or more processors configurable to:
obtain input data including a three-dimensional point cloud of the environment, the three-dimensional point cloud being generated using a three-dimensional laser scanner including multiple laser emitters and multiple laser receivers;
obtain an animation model for an object within the environment, the animation model including a mesh, an animation skeleton rig, and adjustable controls that control the animation skeleton rig to define a position of one or more faces of the mesh; and
determine a pose of the object within the environment, including fitting the one or more faces of the mesh to one or more points of a portion of the three-dimensional point cloud, the portion of the three-dimensional point cloud corresponding to the object in the environment, wherein fitting includes reducing errors between the one or more faces and the one or more corresponding points using the adjustable controls.

9. The system of claim 8, wherein the input data is captured using a plurality of three-dimensional laser scanners, and wherein the plurality of three-dimensional laser scanners operate in synchronization to capture the three-dimensional point cloud of the scene.

10. The system of claim 8, wherein the three-dimensional point cloud is generated using the three-dimensional laser scanner by emitting lasers from the multiple laser emitters, receiving at the multiple laser receivers portions of the emitted lasers reflected by one or more objects, and determining an intensity of the received portions of the emitted lasers, an intensity of a portion of an emitted laser reflected by an object indicating a distance from the three-dimensional laser scanner to the object.

11. The system of claim 8, wherein the three-dimensional laser scanner has a range greater than thirty feet.

12. The system of claim 8, wherein the one or more processors are configurable to:
obtain multiple frames, each frame of the multiple frames including a separate three-dimensional point cloud of the environment; and
determine multiple poses of the object within the environment, wherein a pose of the object is determined for each frame of the multiple frames by refitting the animation model of the object to a portion of each separate three-dimensional point cloud in each frame that corresponds to the object in the environment.

13. The system of claim 8, wherein the three-dimensional point cloud includes a 360 degree azimuth field of view of the environment.

14. The system of claim 8, wherein the three-dimensional laser scanner sequentially generates multiple frames of three-dimensional point clouds in real-time.

15. A computer-readable memory storing a plurality of instructions executable by one or more processors, the plurality of instructions comprising:
instructions that cause the one or more processors to obtain input data including a three-dimensional point cloud of an environment, the three-dimensional point cloud being generated using a three-dimensional laser scanner including multiple laser emitters and multiple laser receivers;
instructions that cause the one or more processors to obtain an animation model for an object within the environment, the animation model including a mesh, an animation skeleton rig, and adjustable controls that control the animation skeleton rig to define a position of one or more faces of the mesh; and
instructions that cause the one or more processors to determine a pose of the object within the environment, including fitting the one or more faces of the mesh to one or more points of a portion of the three-dimensional point cloud, the portion of the three-dimensional point cloud corresponding to the object in the environment, wherein fitting includes reducing errors between the one or more faces and the one or more corresponding points using the adjustable controls.

16. The computer-readable memory of claim 15, wherein the input data is captured using a plurality of three-dimensional laser scanners, and wherein the plurality of three-dimensional laser scanners operate in synchronization to capture the three-dimensional point cloud of the scene.

17. The computer-readable memory of claim 15, wherein the three-dimensional laser scanner has a range greater than thirty feet.

18. The computer-readable memory of claim 15, further comprising:
instructions that cause the one or more processors to obtain multiple frames, each frame of the multiple frames including a separate three-dimensional point cloud of the environment; and
instructions that cause the one or more processors to determine multiple poses of the object within the environment, wherein a pose of the object is determined for each frame of the multiple frames by refitting the animation model of the object to a portion of each separate three-dimensional point cloud in each frame that corresponds to the object in the environment.

19. The computer-readable memory of claim 15, wherein the three-dimensional point cloud is generated using the three-dimensional laser scanner by emitting lasers from the multiple laser emitters, receiving at the multiple laser receivers portions of the emitted lasers reflected by one or more objects, and determining an intensity of the received portions of the emitted lasers, an intensity of a portion of an emitted laser reflected by an object indicating a distance from the three-dimensional laser scanner to the object.

20. The computer-readable memory of claim 15, wherein the three-dimensional laser scanner sequentially generates multiple frames of three-dimensional point clouds in real-time.
